(19) United States
(12) Patent Application Publication
(10) Pub. No.: US 2016/0031187 A1
(43) Pub. Date: Feb. 4, 2016

(54) Flexible Glass/Metal Foil Composite Articles and Production Process Thereof

(71) Applicant: SCHOTT GLASS TECHNOLOGIES (SUZHOU) CO., LTD., Jiang Su (CN)

(72) Inventors: Guangjun ZHANG, Shanghai (CN); Yoshio OKANO, Ibaraki (JP); Pengshu LIU, Suzhou (CN); Sangjin KIM, Seoul (KR); Xiaofeng XU, Jiangsu (CN); Friedrich SIEBERS, Nierstein (DE); Jose ZIMMER, Shanghai (CN)

(21) Appl. No.: 14/880,304

(22) Filed: Oct. 12, 2015

Related U.S. Application Data
(63) Continuation of application No. PCT/CN2013/074023, filed on Apr. 10, 2013.

(51) Int. Cl. B32B 17/06; C03C 17/00; C03C 8/00; C03C 27/04

(52) U.S. Cl. CPC B32B 17/061; C03C 27/044; C03C 17/001; C03C 8/00; B32B 2457/00; B32B 2457/12; B32B 2457/08; B32B 2264/101

(57) ABSTRACT

A flexible article made of glass and metal foil, as well as the production thereof, are provided. The flexible article is a multilayered structure having at least one glass layer and one metal foil layer, and the shear strength between glass and metal foil is above 1 MPa/mm². The glass layer of said flexible article has high electrical resistivity at ambient temperature, low roughness, low thickness, good adherence to metal foil, and the glass in the glass layer has high temperature stability and low flowing temperature, and the thermal expansion coefficient (20 to 300° C.) is 1×10⁻⁶/K to 25×10⁻⁶/K. The whole article is flexible and can be bent, and the curvature radius of the bent flexible article is above 1 mm.

### CROSS REFERENCE TO RELATED APPLICATIONS

This application is a continuation of International Application No. PCT/CN2013/074023 filed Apr. 10, 2013, the contents of which are incorporated by reference herein.

### BACKGROUND OF THE INVENTION

1. Field of the Invention

The invention relates to a flexible article suitable for producing substrates of flexible devices and the production process thereof.

2. Description of Related Art

Flexibility is the trend of development of electronic devices. The substrate of a flexible device can be glass, metal foil and polymer. Polymer has flexibility and high surface smooth, but its temperature stability is low, not meeting the processing requirements of flexible devices, such as displays, lighting equipment, solar cells and so on. For instance, in some cases, the treatment temperature exceeds 600° C., and polymers generally tend to decompose at such a high temperature. Glass also has high surface smooth, but it is difficult to render glass flexible. Normally, the thinner the glass is, the more flexible it is. However, a glass too thin tends to break easily. Handling (e.g. moving and carrying) a thinner glass (e.g. 50 μm) is very difficult due to the key problem of glass breaking. Especially, it is still a far long way to go before the application of the roll-to-roll process into glass processing. Metal foil has good flexibility and it does not easily break, and thus is an alternative for the substrate of flexible devices. However, the surface roughness of metal foil is high, not meeting the requirements of the subsequent film coating for flexible devices. On the other hand, metal foil does not have good insulation for electronic circuits. Therefore, up to now, there are no better substrates for flexible devices.

A good substrate for flexible devices should have high vacuum compatibility, high thermal stability, suitable thermal expansion matching other binding material (e.g. film coating material), high chemical inertness, good surface smoothness and low cost. The flexible articles should have low surface roughness, high temperature stability and high flexibility.

Glass coated steel plates have been gradually developed that are mainly used in the field of bulletproof materials, storage tanks and other storage structures. In these applications, glass coating is mainly used as the corrosion resistant layer. One example of glass coated steel plates is that it is used in the Harvestore feed storage structure, wherein Permaglas borosilicate glass coating is used on both the interior and exterior surfaces of the steel plates. Harvestore and Permaglas are both the trademarks of AO Smith Corporation, which is the manufacturer of the Harvestore structure. The coating on the exterior surface can resist corrosion with respect to weather conditions, and the coating on the interior surface of the structure can resist corrosive attack by the materials stored in the structure. The use of this coating material as bulletproof materials is not reported until now. However, the glass coated steel plates of this type are generally not flexible in view of the application requirements.

U.S. Pat. No. 6,087,013 discloses a glass coated stainless steel with high strength. This patent attaches importance to increasing the strength of the composite material, and a special stainless steel material is used that can only be used for bullet-proof, which means the glass used is also a particular one, and the glass composition and properties are only suitable for coating with this special stainless steel material. What makes things worse is that the glass layer used generally has a thickness of above 380 μm, with the results that the glass having such thickness cannot be bent at all, and in turn cannot be made into the flexible glass metal foil substrate, especially cannot be manufactured in a roll-to-roll process.

US 2012/0064352A1 discloses a composite material of glass and stainless steel. This patent requires a glass precursor, and different precursors are needed to be mixed to form the glass layer, for example, various precursors of compounds containing Si, Al, B, etc. (with solvents) are mixed. Different techniques including rod coating, spray coating, dip coating, microgravure coating or slot die coating are then used to deposit the glass precursor composition onto the stainless steel substrate, and sintered at a temperature of around 800° C. to form glass. The layer of glass is directly combined with stainless steel without any other layered structure there between. This method is not a conventional process to manufacture glass by high temperature melting and cooling. Moreover, this method is only suitable for producing glass with a low softening temperature, such as a softening temperature below 350° C., or even lower if glass forming at a temperature of around 800° C. At such low temperatures, it is almost impossible to form a glass layer with high surface quality, for example, a low sintering temperature would lead to the glass surface with high roughness, wherein the bubbles cannot be effectively dispelled. Furthermore, the glass layer is generally not compact, and has limited temperature resistance. Meanwhile, the glass is apt to be broken when bent as it is not compact.

CN 102803560A relates to an article comprising a metal surface provided with a glass, glass ceramic or ceramic type of protective layer, but the articles is not flexible. The article in the invention exhibits high chemical resistance and improved non-sticky properties, particularly, high resistance to sink washing. It could be understandable that the high chemical resistance is just provided by the glass composition, not any treatment, which means that the glass composition in the invention should be specially designed. Additionally, the method is involved with a sol-gel process where an organic solution is used with something like a precursor being formed, leading to a less density layer. According to the invention, a common alkali silicate and/or alkaline earth metal silicate containing coating composition is applied to a metal surface as the base layer, preferably after being dried or thermal densified, and a further but now alkali metal and alkaline earth metal ion-free coating composition, preferably as a sol-gel layer, is applied and thermally densified to form the top layer. The top layer is able to seal the layer containing alkali or alkaline earth metal ions hermetically, and has a much better chemical resistance than the base layer. Glass powders produced by high temperature melting and cooling are used for both layers. As the layer is formed by a sol-gel process, the glass layer is generally not compact, and has limited temperature resistance. Additionally, the maximum thickness of one layer formed by the glass precursor method is normally lower than 0.5 μm, which could be considered a thin film layer. Although the thickness can be increased by multiple coating, a complex process is required that is not cost-effective. It is also noted in the invention that the glass is apt to be broken when bent as it is not compact.

Currently, there is no glass powder or glass slurry directly produced by using a process of high temperature melting and cooling, and there is no flexible article that is produced by direct laminating of thin glass and metal foil.

### SUMMARY

The invention relates to a flexible article made of glass and metal foil, and the production process thereof. The flexible article has a multilayered structure, for example, having two-layered or three-layered or five-layered structure, wherein at least one layer is metal foil and one surface is glass layer, and the shear strength between the glass and the metal foil is above 1 MPa/mm². The said glass is produced by high temperature melting and cooling in the absence of any precursor. The glass layer of said flexible articles has high electrical resistivity at ambient temperature, low roughness, low thickness, and good adherence with metal foil. The glass in the glass layer has high temperature stability and low flowing temperature, and the thermal expansion coefficient (20 to 300° C.) is 1-25×10⁻⁶/K. The whole article is flexible and can be bent, and the curvature radius of the bent flexible article is more than 1 mm.

The flexible articles have low surface roughness, high temperature thermal stability and high flexibility. The flexible articles can be used as the substrate of flexible devices, such as flexible solar cells, Dye Sensitized Solar Cells (DSSC), Copper Indium Gallium Selenium film solar cells (CIGS), Organic Light-Emitting Diodes (OLED), Printed Circuit Boards (PCB), electronic paper (e-paper), flexible displays, thin film batteries, etc. The glass layer of flexible articles can comprise sodium oxide as a sodium source, and it is particularly suitable for the substrate of CIGS flexible solar cells.

The present invention discloses a process for producing the flexible articles made of glass and metal foil. The glass firstly is produced by high temperature melting and cooling in the absence of any precursors. The raw materials are mixed, and then transported to a tank or furnace. After melting at a temperature such as higher than 800° C., 850° C., 900° C., 1000° C., 1200° C., 1300° C., 1400° C., 1500° C., 1550° C., 1600° C., or 1650° C., the glass is formed through homogenization and refining (removal of bubbles).

What is called “molten glass” is formed at this point. This liquid must then be shaped and very carefully cooled so that the glass comes out strong enough to hold its shape.

By adding other substances during the process, the properties of the glass can be altered, including its color, how reflective it is, how brilliant or sparkling it looks, how well it acts as an insulator and more.

Glass raw material means the raw materials containing various compounds and salts which are of glass composition. All the raw materials to produce glass are inorganic materials, including compounds and salts or mineral, like oxides, carbonates, sulphates, nitrites, phosphates, chlorides, hydroxides, fluorides and other common compounds and salts or mineral used in the art.

One embodiment is to coat glass powders on a metal foil. The glass powders can be produced by casting glass melt into ribbons or pouring glass into water to form small glass pieces, then milling the ribbons or pieces into powders by milling machine. One process is to make use of glass powders for a dry coating process, or a slurry formed by mixing high temperature melted and cooled glass powders and organic solvents. The dry coating process for glass powders is performed preferably by an electrostatic coating process. The time of coating can be shortened by this process because the drying and removing of organic components have been dispensed with. The glass slurry can be coated by use of screen printing, dip coating, spray coating or any other techniques that can be used for coating on the metal foil. After sintering, a glass layer is obtained.

A second embodiment is to laminate a thin glass on a metal foil. The thin glass is also produced by high temperature melting and cooling and can be hot formed by several processes such as micro-float, down-draw, slot draw or fusion draw. The thin glass having a thickness of below 350 μm, 300 μm, 250 μm, 200 μm, 150 μm, 100 μm, 50 μm, 30 μm, 20 μm, 10 μm, 5 μm, 3 μm, 1 μm can be directly laminated on the surface of a metal foil. After thermal treatment, the thin glass can be attached to the surface of the metal foil. In this regard, the thin glass can be directly attached to the metal foil, or the assembly can also be affected by using glass powder or glass slurry as the binder to adhere the thin glass and the metal foil together. The used glass powder and thin glass are both prepared through high temperature melting and cooling. In particular, production processes of the thin glass comprise the up drawing process, the down drawing process, the overflow process or the float process. Composite flexible articles of glass and metal foil with one glass layer, two glass layers or a glass shell can be produced by any one of the above-mentioned processes. Formation of a glass layer on the metal foil can be achieved in an online process or an offline process.

The above methods can form a thicker glass layer covering some “peaks” on the surface of a metal foil. Sometimes, the height of the “peaks” is higher than 1 μm, leading to an increase in the roughness of the metal foil surface, and a decrease in the performance when used in flexible devices. The thickness of the glass layer is higher than 0.05 μm, 0.1 μm, 0.5 μm, 1 μm, 2 μm, 3 μm, 4 μm, 5 μm, 6 μm, 7 μm, 8 μm, 9 μm or 10 μm.

The invention provides a flexible article made of glass and metal foil, especially a flexible article made by assembling of glass and metal foil. This type of composite article is not a simple combination of glass and metal foil, and some factors need to be considered, for example, the coefficient of thermal expansion (CTE) of glass and metal foil should match each other, the CTE (20-300° C.) of glass is 1-25×10⁻⁶/K, 3-15×10⁻⁶/K, 7-12×10⁻⁶/K, 8-11×10⁻⁶/K, 9-11×10⁻⁶/K. The articles made of glass and metal foil should be able to be bent, and the glass does not break when being bent. Generally, the glass can only be bent when the thickness of the glass is below 350 μm, below 300 μm, below 250 μm, below 200 μm, below 150 μm, 100 μm, preferably below 50 μm, below 30 μm, more preferably below 20 μm, below 10 μm, below 5 μm, below 3 μm, below 1 μm. The thinner the glass is, the more flexible it is. However, a separate thin glass is difficult to produce, and difficult to process. The technical problems present in the art have been successfully addressed by the current invention. The invention can provide a thin glass layer with a thickness of below 350 μm, below 300 μm, below 250 μm, below 200 μm, below 150 μm, below 100 μm, below 50 μm, below 30 μm, below 20 μm, below 10 μm, below 5 μm, below 3 μm, below 1 μm on metal foil. The glass on the metal foil is flexible, and it does not break. This type of glass requires specific composition and specific property to make sure it has quite good adhesion to the metal foil and high flexibility. The invention provides the following technical solution, i.e. a glass with a thickness of below 350 μm that can be coated on metal foil can be bent without breaking due to its flexibility. The adhesion between the glass and the metal foil is good, and the shear strength between the glass and the metal foil is above 1 MPa/mm². The glass surface in the invention should have high electrical resistivity at ambient temperature, for example, the electrical resistivity at ambient temperature is above 5×10¹⁰ Ω·m.

Metal foil has the advantages of being flexible and not breaking. However, metal foil has high surface roughness, and it cannot be suitably used for substrates of flexible devices, such as flexible CIGS, DSSC solar cell and OLED devices. Generally, substrates for flexible devices, such as the substrate for CIGS devices requires a toughness of below 100 nm, which exceeds the surface toughness of metal foil as the surface of metal foil has “peaks” with a height of several micrometers. The substrate with high roughness cannot improve the properties of flexible devices.

The invention provides a process to solve the problem of high roughness of the metal foil surface. By use of a glass layer, low surface roughness of below 300 nm, below 250 nm, below 200 nm, below 150 nm, below 100 nm, below 80 nm, below 60 nm, below 50 nm, below 40 nm, below 30 nm, below 20 nm, below 10 nm, below 5 nm, below 1 nm can be achieved. Upon forming a glass layer on metal foil, the glass and the metal foil exhibit good adhesion and flexibility. The shear strength between the glass and the metal foil is above 1 MPa/mm², and the curvature radius of the flexible article is above 1 mm when the article is bent.

The porosity of the surface of the present glass is below 0.1%.

Meanwhile, if the flexible glass metal foil substrate exhibits high temperature stability and has a stable sodium source (provision of sodium diffusion), the flexible glass metal foil substrate can significantly improve the efficiency of the CIGS based solar cell in the case of matching of the two CTE coefficients.

Assembling of glass and metal foil has the following advantages: the thickness of the glass layer can be as low as below 350 μm, and the glass has low surface roughness, good flexibility, high dielectric strength and ion barrier properties. In particular, it can provide the sodium source for CIGS application.

The flexible articles made of glass and metal foil can meet the requirements of a material as the substrate for flexible products with respect to the technical effects set forth below.

Vacuum compatibility. The flexible articles made of glass and metal foil do not need degassing during the various vacuum deposition steps, e.g. during CIGS deposition, when the substrate must be heated.

Thermal stability. The flexible articles made of glass and metal foil can stand a temperature of 400° C. or higher. For growth of high quality semiconductor such as Si, GaAs, CIGS and so on, the substrate temperature should reach 400° C. at least in part of the deposition process. Substrate temperatures of less than about 350° C. usually lead to severely degraded absorber quality and cell performance.

Suitable thermal expansion. The thermal expansion coefficient (CTE) of the substrate must lie in the vicinity of the CTE of relevant semiconductor materials, e.g. CIGS, the CTE of the glass should be 7-10×10⁻⁶/K to meet the requirements.

Chemical inertness. The flexible articles made of glass and metal foil do not corrode no matter of the period of processing or use. In particular, the article does not react (strongly) with Se during the CIGS deposition process or do not decompose during the aqueous solution deposition of the buffer layer (CdS). Also, the flexible articles made of glass and metal foil do not release any impurities that can diffuse into the absorber unless it is otherwise explicitly desired.

Surface smoothness. The smooth surface of the flexible articles made of glass and metal foil has two advantages compared with that of the unsmooth surface. First, abrupt changes in the surface topography may lead to short-cut between the front contact and the back contact, therefore the more smooth the surface is, the better the quality is. Second, the deposition of impurity diffusion barriers or insulation coatings may be even easier and even more successful.

Costs, energy consumption, abundance and weight. Obviously, the ideal substrate is cheap with a small amount of energy for its production, consists of various lightweight materials.

“Softening temperature” in the current invention is intended to mean the temperature at which the viscosity of glass is about 10^{7.6} d Pa·s.

“Flowing temperature” in the current invention is intended to mean the temperature at which the glass starts to flow. At the flowing temperature, glass powder melts. The surface is smooth without visible surface irregularities. The flowing temperatures can be achieved within a viscosity range of the glass from 10⁴ to 10⁶ d Pa·s depending on factors such as compositions and grain sizes of the glass powder. The glass has a T_{g} (glass transition point) of above 400° C., 450° C., 480° C., 500° C., 530° C., 550° C., 580° C., 600° C., or 620° C. A flowing temperature of below 1200° C., 1150° C., 1050° C., 950° C., 900° C., 850° C., 800° C., 750° C., 700° C., 650° C. or 600° C. The glass has a softening temperature of above 400° C. and a flowing temperature of below 1200° C., preferably the glass has a softening temperature of above 500° C. and a flowing temperature of below 1200° C., even preferably the glass has a softening temperature of above 500° C. and a flowing temperature of below 1150° C., more preferably the glass has a softening temperature of above 550° C. and a flowing temperature of below 1050° C., most preferably the glass has a softening temperature of above 600° C. and a flowing temperature of below 950° C.

“Flexibility” in the current invention is intended to mean that the product can meet the requirements for a roll-to-roll process.

“Curvature radius” in the current invention is intended to mean the degree of curvature under the action of force featuring the articles. The larger the circular arc is, the smaller the degree of curvature is, and it is even more similar to a line. The larger the circular arc is, the smaller the curvature is, and the larger the curvature radius is. The curvature radius of the present articles is above 1 mm, above 5 mm, above 10 mm, above 20 mm, above 30 mm, above 40 mm, above 50 mm, above 80 mm, above 100 mm, above 150 mm, above 200 mm, above 250 mm, above 300 mm, above 350 mm, above 400 mm, above 450 mm, above 500 mm.

“Shear strength” in the current invention is intended to mean the ability of the two interfaces of a composite material to stand shear force. The shear strength represents the degree of firmness of the adhesion between the glass layer and the metal foil layer. The larger the shear strength is, the firmer the adhesion is, which shows the glass metal foil composite articles have excellent process properties. The shear strength between the glass and the metal foil in the present invention is above 1 MPa/mm², above 10 MPa/mm², above 30 MPa/mm², above 50 MPa/mm², above 70 MPa/mm², above 100 MPa/mm², above 150 MPa/mm², above 200 MPa/mm², above 250 MPa/mm², above 300 MPa/mm², above 350 MPa/mm² and above 400 MPa/mm².

“Surface roughness” in the current invention is intended to mean a surface roughness with a peak to peak distance of below 300 nm, below 250 nm, below 200 nm, below 150 nm, below 100 nm, below 80 nm, below 60 nm, below 50 nm, below 40 nm, below 30 nm, below 20 nm, below 10 nm, below 5 nm, and below 1 nm.

The surface of the glass layer (not the surface that contacts metal foil) is preferably a fire-polishing surface, the surface roughness (RMS) R_{q} is preferably not more than 100 nm, more preferably at most 50 nm, more preferably at most 10 nm, even preferably at most 1 nm, in particular preferably at most 0.8 nm, in particular preferably at most 0.5 nm. At least one of the two sides of the glass layer has a mean roughness Rₐ of at most 300 nm, preferably at most 250 nm, more preferably at most 200 nm, more preferably at most 100 nm, more preferably at most 50 nm, more preferably at most 10 nm, in particular preferably at most 1.5 nm, in particular preferably at most 1 nm.

The electric resistivity of glass in the invention is intended to mean the electric resistivity at room temperature (25° C.), unless otherwise indicated, for instance, in some examples, the electric resistivity values are measured at a temperature of 250° C. or 350° C.

The expansion of thermal coefficient (CTE), i.e. CTE in the invention is intended to mean the thermal expansion coefficient in the temperature range of 20-300° C. The thermal expansion coefficient (20-300° C.) CTE of the present glass is 1-25×10⁻⁶/K, 2-18×10⁻⁶/K, 3-15×10⁻⁶/K, 4-14×10⁻⁶/K, 6-14×10⁻⁶/K, 6-12×10⁻⁶/K, 7-10×10⁻⁶/K, 7-9×10⁻⁶/K, 7-8×10⁻⁶/K, 7-12×10⁻⁶/K, 8-12×10⁻⁶/K, 8-11×10⁻⁶/K, 10-11×10⁻⁶/K, 9-12×10⁻⁶/K, 9-11×10⁻⁶/K, 10-15×10⁻⁶/K, or 10-12×10⁻⁶/K.

“Thin glass lamination” in the current invention means direct laminating of thin glass and metal foil, or adhering thin glass to metal foil through glass powder or glass slurry.

“Online process” in the current invention means a metal foil is directly coated with glass powder or glass slurry or laminated with thin glass during the production process. For instance, electrostatic coating, screen printing or online thermal spray coating is directly integrated into a metal foil production line. After cooling the metal foil, a glass layer is formed on the surface of the metal foil, then a roll to roll process can be adopted.

“Offline process” in the current invention is intended to mean a product metal foil available in the market is further coated with glass powder or glass slurry or laminated with thin glass.

Either in online process or in offline process, the treatment in the invention can be carried out in air, weak reducing atmosphere (atmosphere with a small amount of oxygen), nitrogen, or a mixture of nitrogen and hydrogen, such as 90% N₂+10% H₂.

The glass in the flexible articles of the invention comprises silicate glass, phosphate glass, borosilicate glass, aluminosilicate glass, boroaluminosilicate glass, tin phosphate glass, borophosphate glass, titanate glass, barium glass, etc.

In the glass in the flexible article of the invention, the content of Na₂O+SiO₂+P₂O₅+B₂O₃+SO₃+V₂O₅+TiO₂+BaO+ZnO is 10-95 wt. %.

The glass comprises at least one type of glass former, and the content of SiO₂+P₂O₅+B₂O₃ is 10-90 wt. %, the glass of the invention preferably has the following composition:

| Composition | (wt. %) |
|---|---|
| SiO₂ | 10-90 |
| Al₂O₃ | 0-40 |
| B₂O₃ | 0-80 |
| Na₂O | 0-30 |
| K₂O | 0-30 |
| CoO | 0-20 |
| NiO | 0-20 |
| Ni₂O₃ | 0-20 |
| MnO | 0-20 |
| CaO | 0-40 |
| BaO | 0-60 |
| ZnO | 0-40 |
| ZrO₂ | 0-10 |
| MnO₂ | 0-10 |
| CeO | 0-2 |
| SnO₂ | 0-2 |
| Sb₂O₃ | 0-2 |
| TiO₂ | 0-40 |
| P₂O₅ | 0-70 |
| MgO | 0-40 |
| SrO | 0-60 |
| Li₂O | 0-30 |
| Li₂O + Na₂O + K₂O | 1-30 |
| SiO₂ + B₂O₃ + P₂O₅ | 10-90 |
| Nd₂O₅ | 0-20 |
| V₂O₅ | 0-50 |
| Bi₂O₃ | 0-50 |
| SO₃ | 0-50 |
| SnO | 0-70 |

The glass comprises 0-2 wt. % of As₂O₃, Sb₂O₃, SnO₂, SO₃, Cl, F and/or CeO₂ as refining agents, and the total amount of each component is 100%.

The glass of the invention preferably has the following composition:

| Composition | (wt. %) |
|---|---|
| SiO₂ | 10-90 |
| Al₂O₃ | 0-40 |
| B₂O₃ | 0-80 |
| Na₂O | 1-30 |
| K₂O | 0-30 |
| CoO | 0-20 |
| NiO | 0-20 |
| Ni₂O₃ | 0-20 |
| MnO | 0-20 |
| CaO | 0-40 |
| BaO | 0-60 |
| ZnO | 0-40 |
| ZrO₂ | 0-10 |
| MnO₂ | 0-10 |
| CeO | 0-2 |
| SnO₂ | 0-2 |
| Sb₂O₃ | 0-2 |
| TiO₂ | 0-40 |
| P₂O₅ | 0-70 |
| MgO | 0-40 |
| SrO | 0-60 |
| Li₂O | 0-30 |
| Li₂O + Na₂O + K₂O | 5-30 |
| SiO₂ + B₂O₃ + P₂O₅ | 10-90 |
| Nd₂O₅ | 0-20 |
| V₂O₅ | 0-50 |
| Bi₂O₃ | 0-50 |
| SO₃ | 0-50 |
| SnO | 0-70 |

The glass comprises 0-2 wt. % of As₂O₃, Sb₂O₃, SnO₂, SO₃, Cl, F and/or CeO₂ as refining agents, and the total amount of each component is 100%.

In addition, the glass can also comprise PbO, when necessary.

In order to meet the requirements of the substrate of flexible devices when in use, more specifically, the optimized suitable glass system is such as soda lime glass, borosilicate glass, aluminosilicate glass, lithium aluminosilicate glass. The production process of the glass comprises the up drawing process, the down drawing process, the overflow process, or the float process.

Preferably, the lithium aluminosilicate glass composition with the following composition is used as the glass layer, the glass comprises (in wt. %):

| Composition | (wt. %) |
|---|---|
| SiO₂ | 55-69 |
| Al₂O₃ | 19-25 |
| Li₂O | 3-5 |
| Na₂O | 0.5-15 |
| the sum of Na₂O + K₂O | 0.5-15 |
| the sum of | 0-5 |
| MgO + CaO + SrO + BaO | |
| ZnO | 0-4 |
| TiO₂ | 0-5 |
| ZrO₂ | 0-3 |
| the sum of | 2-6 |
| TiO₂ + ZrO₂ + SnO₂ | |
| P₂O₅ | 0-8 |
| F | 0-1 |
| B₂O₃ | 0-2 |

Optionally, coloring oxides can be added, such as Nd₂O₃, Fe₂O₃, CoO, NiO, V₂O₅, MnO₂, TiO₂, CuO, CeO₂, Cr₂O₃, 0-1 wt. % of rare earth oxides, and 0-2 wt. % of As₂O₃, Sb₂O₃, SnO₂, SO₃, Cl, F and/or CeO₂ as refining agents.

Preferably, the soda lime glass composition with the following composition is used as the glass layer, the glass comprises (in wt. %):

| Composition | (wt. %) |
|---|---|
| SiO₂ | 40-80 |
| Al₂O₃ | 0-6 |
| B₂O₃ | 0-5 |
| the sum of Li₂O + Na₂O + K₂O | 5-30 |
| the sum of | 5-30 |
| MgO + CaO + SrO + BaO + ZnO | |
| the sum of TiO₂ + ZrO₂ | 0-7 |
| P₂O₅ | 0-2 |

Optionally, coloring oxides are added, such as Nd₂O₃, Fe₂O₃, CoO, NiO, V₂O₅, MnO₂, TiO₂, CuO, CeO₂, Cr₂O₃, 0-1 wt. % of rare earth oxides, and 0-2 wt. % of As₂O₃, Sb₂O₃, SnO₂, SO₃, Cl, F and/or CeO₂ as refining agents.

Preferably, the borosilicate glass composition with the following composition is used as the glass layer, the glass comprises (in wt. %):

| Composition | (wt. %) |
|---|---|
| SiO₂ | 60-85 |
| Al₂O₃ | 1-10 |
| B₂O₃ | 5-20 |
| the sum of Li₂O + Na₂O + K₂O | 2-16 |
| the sum of | 0-15 |
| MgO +CaO + SrO + BaO + ZnO | |
| the sum of TiO₂ + ZrO₂ | 0-5 |
| P₂O₅ | 0-2 |

Optionally, coloring oxides are added, such as Nd₂O₃, Fe₂O₃, CoO, NiO, V₂O₅, MnO₂, TiO₂, CuO, CeO₂, Cr₂O₃, 0-1 wt. % of rare earth oxides, and 0-2 wt. % of As₂O₃, Sb₂O₃, SnO₂, SO₃, Cl, F and/or CeO₂ as refining agents.

Preferably, the alkali metal aluminosilicate glass composition with the following composition is used as the glass layer, the glass comprises (in wt. %):

| Composition | (wt. %) |
|---|---|
| SiO₂ | 40-75 |
| Al₂O₃ | 10-30 |
| B₂O₃ | 0-20 |
| the sum of Li₂O + Na₂O + K₂O | 4-30 |
| the sum of | 0-15 |
| MgO + CaO + SrO + BaO + ZnO | |
| the sum of TiO₂ + ZrO₂ | 0-15 |
| P₂O₅ | 0-10 |

Optionally, coloring oxides are added, such as Nd₂O₃, Fe₂O₃, CoO, NiO, V₂O₅, MnO₂, TiO₂, CuO, CeO₂, Cr₂O₃, 0-1 wt. % of rare earth oxides and 0-2 wt. % of As₂O₃, Sb₂O₃, SnO₂, SO₃, Cl, F and/or CeO₂ as refining agents.

Preferably, low (or no) alkali metal aluminosilicate glass composition with the following composition is used as the glass layer, the glass comprises (in wt. %):

| Composition | (wt. %) |
|---|---|
| SiO₂ | 50-75 |
| Al₂O₃ | 7-25 |
| B₂O₃ | 0-20 |
| the sum of Li₂O + Na₂O + K₂O | 0-4 |
| the sum of | 5-25 |
| MgO + CaO + SrO + BaO + ZnO | |
| the sum of TiO₂ + ZrO₂ | 0-10 |
| P₂O₅ | 0-5 |

Optionally, coloring oxides are added, such as Nd₂O₃, Fe₂O₃, CoO, NiO, V₂O₅, MnO₂, TiO₂, CuO, CeO₂, Cr₂O₃, 0-1 wt. % of rare earth oxides, 0-15 wt. % of “black glass” and 0-2 wt. % of As₂O₃, Sb₂O₃, SnO₂, SO₃, Cl, F and/or CeO₂ as refining agents.

Some examples of the glass of the invention are listed in Table 1, but the glass of the invention is not limited to the listed glass compositions in Table 1.

The glass has a softening temperature of above 350° C., above 400° C., above 450° C., above 500° C., above 550° C., above 600° C., above 650° C., above 700° C. or above 800° C. and a flowing temperature of below 1200° C., below 1100° C., below 1000° C., below 950° C., below 900° C., below 850° C., below 800° C., below 750° C. or below 700° C.

The glass layer of the invention generally has a thickness of at most 350 μm, at most 300 μm, 200 μm, 150 μm, preferably at most 100 μm, preferably at most 50 μm, in particular preferably at most 30 μm, at most 20 μm, 10 μm, at most 5 μm, or at most 3 μm. Preferably, the thin glass has a thickness of 0.1 μm, 0.5 μm, 1 μm, 2 μm, 3 μm, 4 μm, 5 μm, 6 μm, 7 μm, 8 μm, 9 μm, 10 μm, 15 μm, 20 μm, 25 μm, 30 μm, 35 μm, 50 μm, 55 μm, 70 μm, 80 μm, 100 μm, 130 μm, 145 μm, 160 μm, 190 μm, 210 μm, 280 μm, 300 μm or 350 μm.

In another aspect of the invention, the glass of the invention can be converted to a glass ceramic through thermal treatment. Glass ceramic is one type of crystallized glass. The whole glass layer can be crystallized, or part of the glass layer can be crystallized, for example, only the upper surface and lower surface of the glass layer are crystallized. The glass ceramic material has various properties of glass and ceramic. Glass ceramic has an amorphous phase and one or more crystalline phases, which is prepared through “crystallization control” in contrast to spontaneous crystallization that is not desired in glass production. Glass ceramic generally has 30-90 vol % of crystalline phase, and thus can be used to produce a series of materials with interesting mechanical properties, such as the glass with improved strength.

The glass ceramic of the invention is prepared through the process described in the examples. During the glass production process, raw materials are firstly melted at a high temperature higher than 1000° C., 1200° C., 1300° C., 1400° C., 1500° C., 1550° C., 1600° C., 1650° C. to form glass, the glass melt is formed after homogenizing, and then nucleation and crystallization is carried out at a certain temperature after annealing, in order to obtain glass ceramic articles having the homogenous structure with fine grains. The resulting glass ceramic generally does not have pores.

Typically, for the sake of crystallization (crystal nucleus formation), suitable crystallizing agents can be used, such as TiO₂, ZrO₂, HfO₂ or other known components to dope the glass, wherein the total amount of the crystallizing agents is at most 5 wt. %, preferably at most 3 wt. %, and more preferably at most 2 wt. % relative to the total of the glass composition.

During the glass forming process, in particular when the float process is used, the viscosity is a key indicator of glass. For float forming, it is required that the materials are short so as to be suitable for high speed drawing and rapid forming. The viscosity of the present glass during thermal forming process is 1.5×10³ to 8×10⁶ Pa·s, and the difference in temperature corresponding to the viscosity can be used to characterize the hardening speed of the float glass, i.e. ΔT=T₃ (the temperature where the viscosity is 1.5×10³ Pa·s)−T₆ (the temperature where the viscosity is 8×10⁶ Pa·s). The viscosity range of the present invention is suitable for float process, and meanwhile it is suitable for other production processes, such as the down drawing process, the up drawing process, the overflow process.

In the invention, the crystalline phase of the glass ceramic has a structure as a “high quartz” solid solution or a structure of crystalline phases such as lithium disilicate, barium disilicate, enstatite, wollastonite, stuffed β-quartz, β-spodumene, cordierite, mullite, potassium richterite, canasite, spinel solid solution, quartz or borate.

The glass metal foil composite articles of the invention can be chemically-toughened. This toughening means chemical toughening of the glass layer.

Typically, high strength is achieved for glass through ion exchange process carried out in low temperature environment called chemical toughening. Chemical toughening can increase the strength of glass, and thus resist scratching and impact to avoid breaking Chemical toughening is adopted to generate the surface compressive stress of glass through ion exchange. The simple principle of ion exchange process is described as follows: the ion exchange is carried out in a salt solution, such as NaNO₃, KNO₃ or a mixture of NaNO₃ and KNO₃ at a temperature of around 350° C.-490° C., wherein the ions with a smaller radius on the surface of the glass are exchanged with the ions with a larger radius in the liquid, for example, the sodium ions in the glass are exchanged with the potassium ions in the solution, thereby generating the surface compressive stress due to the volume difference between the alkali ions. This process is in particular suitable for glass with a thickness of below 4 mm. Chemically toughened glass has the following advantages: it does not lead to glass warpage, and the surface evenness is the same as that of the original glass; meanwhile, the chemically toughened glass has the improved strength and resistance to temperature variation to some extent, and then is suitable for cutting. The strength of glass can be characterized with CS (surface compressive stress) and DoL (depth of the surface stress layer). In the practical use, a high CS and a high DoL are required. The glass having relatively high strength can be obtained by reasonable control of DoL (depth of the surface stress layer) and CS (surface compressive stress). The size of DoL (depth of the surface stress layer) and CS (surface compressive stress) is dependent on the glass composition, in particular on the amount of alkali metals in the glass and the toughening conditions comprising time and temperature as well. During chemical toughening, the compressive stress layer can be formed on the surface of the glass. According to the ion diffusion principle, the depth of the compressive stress layer is proportional to the square root of the toughening time. The longer the toughening time is, the deeper the toughened layer is, the smaller the surface compressive stress is, and the larger the central tensile stress is. When the toughening time is too long, the surface compressive stress will be decreased due to increase in the central tensile stress and relaxation in the glass structure, and the strength of the glass is reduced instead. Therefore, there is an optimized toughening time to strike a balance between the surface compressive stress, the depth of the toughened layer and the central tensile stress, achieving the glass with optimized strength. The optimized toughening time varies with the glass composition, the salt bath composition and the toughening temperature.

After ion exchange, the compressive stress is formed on the glass surface, and thus the strength of the glass is increased. In order to counteract the compressive stress on the glass surface, the tensile stress is formed in the center of the glass. Tensile stress if too high would increase the risk of glass breaking. The bended glass member is more sensitive to the central tensile stress under the action of external force.

The glass layer of the glass metal foil flexible article of the invention can be subjected to ion exchange in NaNO₃, KNO₃ or a mixture of NaNO₃ and KNO₃. The depth of ion exchange (DoL) is above 1 μm, above 5 μm, above 10 μm, above 20 μm, above 30 μm, above 40 μm, above 50 μm, above 60 μm, above 100 μm, and the compressive stress (CS) is above 200 MPa, above 300 MPa, above 400 MPa, above 500 MPa, above 600 MPa, above 700 MPa, above 800 MPa, above 900 MPa, or above 1000 MPa.

The glass slurry of the invention is coated by use of the process technique of screen printing. Check of printing plate generally includes the following items: whether the printing plate has sand holes or breakages, whether there is looseness in the installment between the printing plate and the base plate, whether the grid length is suitable, and whether the printing registration is correct. Doctor blade is required and its length should be slightly longer than the length of the printing area. For instance, a steel doctor blade or a rubber doctor blade can be used. The rubber doctor blade should have certain flexibility to advantageously improve the contacting properties between the screen plate and the glass and metal foil, rendering the printing ink uniform. It is required that the doctor blade should be level, and the doctor blade can be manufactured from 5 mm acid resistant rubber. Slurry formulation is the key point and the types and components of the slurry should be determined according to the base plate and the printing requirements. And the key points of formulation are to control the dryness and the viscosity to meet as much requirements of doctor blade printing as possible. The slurry should be prepared in advance and stored for one day to make the property thereof stable. It should also be examined whether there are foreign matters in the slurry in order to avoid scratching of the printing plate during doctor blade printing. To avoid agglomerates the slurry can be treated in a three roller mill. The slurry is generally poured at the initial position in front of the screen frame and within the width range of the doctor blade. It is not necessary to place too much slurry into the screen frame, and the slurry can be added whenever needed for the purpose of easy control of the amount of ink during doctor coating. Screen printing comprises the following procedures set forth below.

### Doctor Blade Printing:

The substrate is held by hands and placed on the board provided with a register, the screen frame is set down, and a certain grid length is retained between the printing plate and the board.

The doctor blade is held by hands and is pressed downward to the screen, and an angle of 50-60° should be maintained when the doctor blade scraping. The doctor blade performs the movement of ink scraping at a certain speed, so that the slurry can be printed to the substrate by print-through from the screen meshes in the graph-text cutout portion under the action of pressure of the doctor blade. The screen rebounds and separates from the substrate after the doctor blade passing. The doctor blade printing operation can be handled by single hand or double hands according to the size of the printing area and the length of the scraper, but the amount of the slurry should be well controlled and the surface of the printing plate should be kept clean.

The screen frame is lift up, and the glass metal foil is removed from the board.

### Screen Plate Washing:

During printing, whenever blurred imprinting and meshes clogging occur, the printing plate needs washing. Absorbent cotton or soft cloth dipped with solvents is used to wipe the front and back surfaces of the screen plate gently. During washing, the graph-text portion should be firstly washed, and then the other portions. Both the front surface and the back surface of the printing plate should be washed clean, and the meshes clogging portion needs dredging and the solvents on the printing plate should be blotted. After finishing printing, the printing plate should also be washed clean.

Drying after Printing:

After each printing, drying is carried out to ensure the power of attachment. Some substrates easily expand and shrink due to weather changes, thus an imprecise overprint would occur if the substrate is not subjected to overprint in time and allowing the substrate to stand for a long time, to which attention should be paid during drying.

The organic components used in the invention to prepare the glass slurry comprise: Alcohol solvents: ethyl alcohol (ethanol), isopropanol, n-butanol; Ester solvents: ethyl acetate, butyl acetate, isopropyl acetate; Aromatic solvents: toluene, xylene; Ketone solvents: cyclohexanone, acetone, methyl ethyl ketone (butanone).

Preferably, the organic components comprise ethyl cellulose, terpineol, turpentine, alkyd.

The metal foil of the invention is selected from Fe, Cu, Al, Cr, Co, Ag, Ni, or selected from a member of alloys of Fe, Cu, Al, Cr, Co, Ag or Ni, such as stainless steel, copper alloy, aluminum alloy, titanium alloy, etc. The metal glass can comprise 1) an eutectic mixture. When the eutectic mixture solidifies, each component individually crystallizes and in turn forms an alloy, such as bismuth cadmium alloy. The lowest melting point of bismuth cadmium alloy is 413 K, and at this temperature, the bismuth cadmium eutectic mixture comprises 40% of cadmium and 60% of bismuth. 2) Solid solution, which is a type of metal crystal formed by each component, wherein the solute atoms dissolve into the lattices of the solvent while the type of lattice of the solvent is still retained. Some solid solution alloys are formed by replacing some solvent atoms with solute atoms at the lattice sites of the solvent metal. 3) Intermetallic compound, which is an alloys that can be formed from the interaction of each and every component. Generally, the melting point of the alloy is lower than that of any metal as a component constituting the alloy.

The preferable metal foils in the invention comprise stainless steel (1.4310C, SUS201, SUS301, SUS304, SUS430), and the thickness of the stainless steel foil is 0.005-1 mm. Suitable metal foils can be sheet, or other shapes, and it is most preferred for the sheet metal foil to be processed by the roll-to-roll process. Preferable stainless steel foils generally comprise 13-22 wt % of chromium, 1.0-10 wt % of aluminum, below 2.1 wt % of manganese, below 1.1 wt % of silicon, below 0.13 wt % of carbon, below 10.6 wt % of nickel, below 3.6 wt % of copper, below 0.15 wt % of nitrogen, below 0.05 wt % of phosphor, below 0.04 wt % of sulfur and below 0.04 wt % of niobium, and the remaining is iron.

In some embodiments, the stainless steel comprises about 12 wt % of chromium, 3.0-3.95 wt % of aluminum, below 1.4 wt % of titanium, about 0.35 wt % of manganese, about 0.3 wt % of silicon, and about 0.025 wt % of carbon, characterized in that the remaining component is iron. In some other embodiments, the stainless steel comprises about 22 wt % of chromium and about 5.8 wt % of aluminum, characterized in that the remaining component is iron.

In another embodiment, a certain grade of stainless steel is suitable, characterized in that, the stainless steel is substantially free of aluminum. For example, stainless steel of grade 430 and stainless steel of grade 304 are suitable for the invention, but they are substantially free of aluminum as a constituting component of stainless steel.

The metallic surface or the metallic substrate may have a flat or structured surface, wherein a structured surface is preferred for the metallic surface. Said structured surface may be a microstructured surface or a structure of greater dimensions. The said structure may be regular, as obtained, for example, by embossing, or irregular, as obtained, for example, by roughening for which brushing, sandblasting or shot-peening are common methods.

The flexible articles of the invention are suitable for subsequent processing, such as, cutting, surface milling, surface polishing and surface drilling, etc. Further, patterns can also be produced on the surface.

### BRIEF DESCRIPTION OF THE DRAWINGS

FIG. 1 An embodiment of the flexible articles of the invention, wherein 10 is a glass layer, and 11 is a metal foil;

FIG. 2 An other embodiment of the invention, wherein 20 is a glass layer, 21 is metal foil, and 22 is a glass layer;

FIG. 3 An other embodiment of the invention, wherein 30 is a glass layer, and 31 is metal foil;

FIG. 4 An other embodiment of the invention, wherein 40 is a glass layer, 41 is a glass layer formed by glass powder or glass slurry, 42 is a metal foil, 43 is a glass layer formed by glass powder or glass slurry, and 44 is a glass layer;

FIG. 5 An other embodiment of the invention, wherein 50 is a glass layer, 51 is glass powder or glass slurry, and 52 is a metal foil;

FIG. 6 An other embodiment of the invention, wherein 60 is a glass ceramic layer, 61 is a glass layer, 62 is a glass ceramic layer, and 63 is metal foil;

FIG. 7 The surface of the metal foil SUS 430;

FIG. 8 The surface of the metal foil SUS 430 after glass coating and

FIG. 9 A glass/metal composite article that can be bent.

FIG. 10 Glass layer formed on the steel by using high temperature melting and cooling.

FIG. 11 Glass layer formed on the steel by using sol-gel.

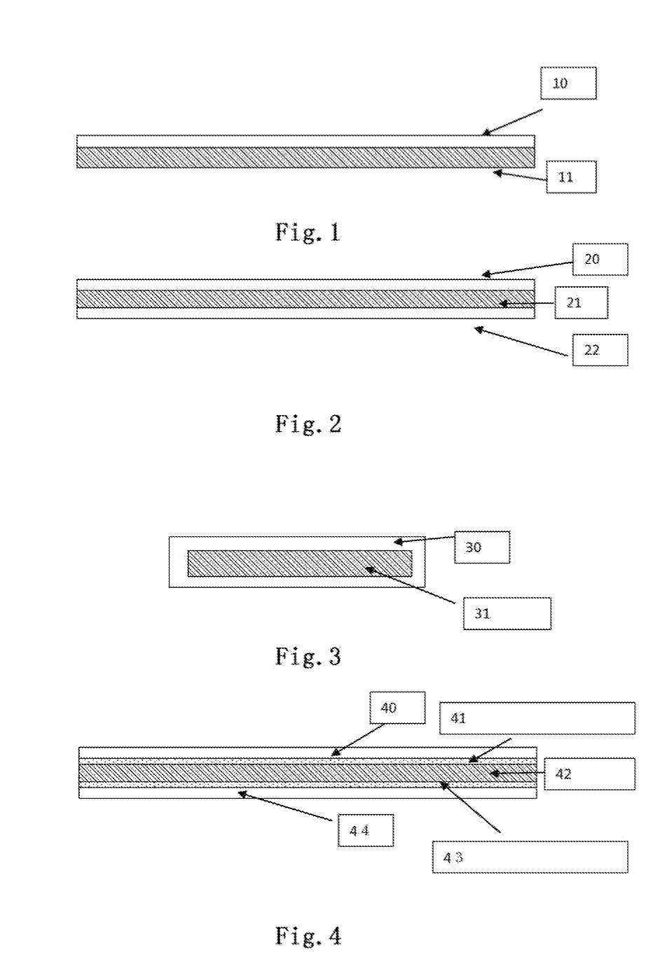

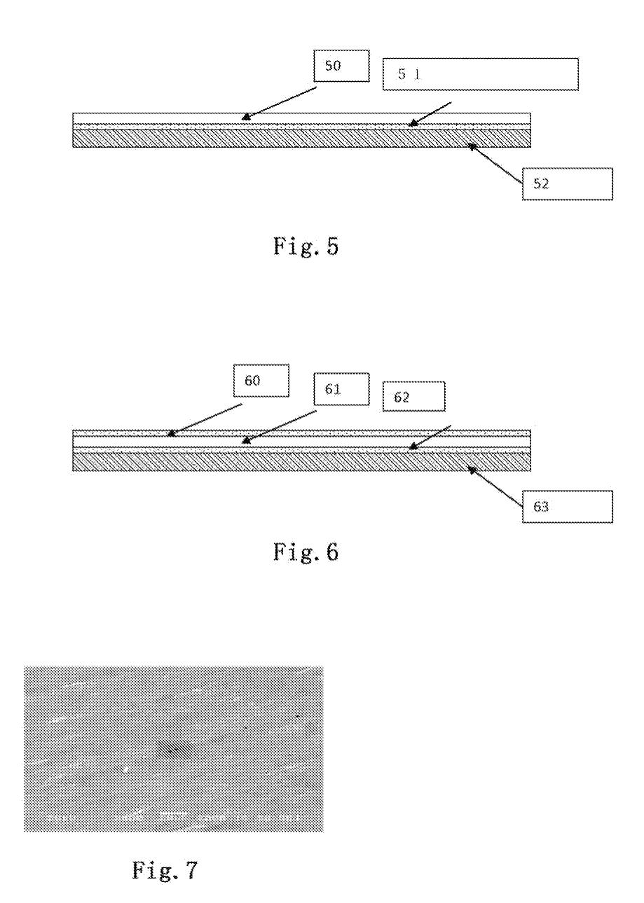

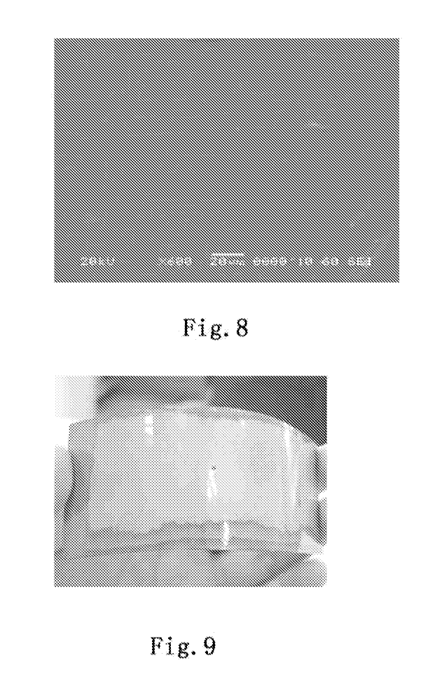

### DETAILED DESCRIPTION

The electric resistance is measured using the four point probe method.

The curvature radius that is measured in the current invention is the radius of the circular arc formed under the action of certain external force.

The shear strength is measured by the junction surface of a shearing sample of the composite steel plate being subjected to shearing with a corresponding shearing apparatus under the action of static pressure (tension) until its breaking.

Glass compositions

| | wt. % | | | | | | | | | |
|---|---|---|---|---|---|---|---|---|---|---|
| Composition | glass 1 | glass 2 | glass 3 | glass 4 | glass 5 | glass 6 | glass 7 | glass 8 | glass 9 | glass 10 |
| SiO₂ | 18.96 | 37.35 | 36.82 | 0.52 | 0 | 36.82 | 30.76 | 74.42 | 40.29 | 32.99 |
| Al₂O₃ | 0 | 1 | 26.77 | 0 | 0 | 10.55 | 14.32 | 0 | 3.21 | 0 |
| B₂O₃ | 71.71 | 6.47 | 14.3 | 1.33 | 3.92 | 25.46 | 34.04 | 12.03 | 0 | 2.85 |
| Na₂O | 9.33 | 0 | 12.47 | 0.52 | 11.05 | 12.47 | 10.49 | 5.62 | 13.46 | 15.3 |
| K₂O | 0 | 0 | 3.65 | 0.55 | 0 | 3.65 | 0 | 3.2 | 7.68 | 5.11 |
| CoO | 0 | 0 | 0 | 0 | 0 | 0 | 0 | 0 | 0 | 0 |
| NiO | 0 | 0 | 0 | 0 | 0 | 0 | 0 | 0 | 0 | 0 |
| Ni₂O₃ | 0 | 0 | 0 | 0 | 0 | 0 | 0 | 0 | 0 | 0 |
| MnO | 0 | 0 | 0 | 0 | 0 | 0 | 0 | 0 | 0 | 0 |
| CaO | 0 | 3.49 | 4.56 | 0.66 | 3.29 | 9.63 | 3.94 | 0 | 1.59 | 2.91 |
| BaO | 0 | 43.82 | 0 | 1.7 | 0 | 0 | 6.45 | 0 | 4.11 | 0 |
| ZnO | 0 | 4.98 | 0 | 1.7 | 33.42 | 0 | 0 | 0 | 0 | 0 |
| ZrO₂ | 0 | 2.49 | 0 | 0 | 0 | 0 | 0 | 0 | 0.21 | 0 |
| MnO₂ | 0 | 0 | 1.03 | 0 | 0 | 1.02 | 0 | 0 | 0 | 0 |
| CeO | 0 | 0.1 | 0.1 | 0 | 0 | 0.1 | 0 | 0 | 0 | 0 |
| SnO₂ | 0 | 0.3 | 0.3 | 0 | 0 | 0.3 | 0 | 0 | 0 | 0 |
| Sb₂O₃ | 0 | 0 | 0 | 0 | 0 | 0 | 0 | 4.35 | 0.03 | 0.11 |
| TiO₂ | 0 | 0 | 0 | 0 | 0 | 0 | 0 | 0.38 | 25.2 | 29.16 |
| P₂O₅ | 0 | 0 | 0 | 0 | 33.3 | 0 | 0 | 0 | 0 | 0 |
| MgO | 0 | 0 | 0 | 0 | 0 | 0 | 0 | 0 | 0 | 0 |
| SrO | 0 | 0 | 0 | 0 | 0 | 0 | 0 | 0 | 0 | 0 |
| Li₂O | 0 | 0 | 0 | 0.89 | 0 | 0 | 0 | 0 | 0.2 | 2.89 |
| Li₂O + Na₂O + K₂O | 9.33 | 0 | 16.12 | 1.96 | 11.05 | 16.12 | 10.49 | 8.82 | 21.34 | 23.3 |
| SiO₂ + B₂O₃ + P₂O₅ | 90.670 | 43.82 | 51.12 | 1.85 | 37.22 | 62.28 | 64.8 | 86.45 | 40.29 | 35.84 |
| Nd₂O₅ | 0 | 0 | 0 | 0 | 0 | 0 | 0 | 0 | 4.02 | 8.68 |
| V₂O₅ | 0 | 0 | 0 | 0.28 | 0 | 0 | 0 | 0 | 0 | 0 |
| SO₃ | 0 | 0 | 0 | 37.36 | 15.02 | 0 | 0 | 0 | 0 | 0 |
| SnO | 0 | 0 | 0 | 54.49 | 0 | 0 | 0 | 0 | 0 | 0 |
| Properties | | | | | | | | | | |
| T_{g} (° C.) | 383 | 734 | 550 | 322 | 357 | 547 | 525 | 498 | 524 | 508 |
| CTE(×10⁻⁶/K) | 8.2 | 9.86 | 8.96 | 9 | 13.14 | 8.47 | 7.47 | 7.3 | 11.1 | 11.1 |
| AT (° C.) | 437 | 840 | 629 | 386 | 397 | 600 | 577 | 546 | 580 | 547 |
| Flowing temperature | 600 | 920 | 890 | 560 | 580 | 870 | 850 | 890 | 750 | 720 |
| (° C.) | | | | | | | | | | |
| T13.6 (dPa · s) | | | | | | | | | | |
| T7.6 (dPa · s) | | | | | | | | 657 | 625 | 602 |
| T4 (dPa · s) | | | | | | | | 924 | 782 | 745 |

wherin T13.6 represents the strain point of the glass;
T7.6 represents the softening point of the glass; and
T4 represents the working point of the glass.

### Example 1

According to the composition of glass 1 in Table 1, the raw materials used are oxides, hydroxides, carbonates, and nitrates, etc. After weighting and mixing the raw materials, the mixture is placed into a platinum crucible. The mixture is melted at 1550-1600° C. in an electric furnace, then made into a ribbon by a rotating device. The ribbon is milled into powder through a milling device. The medium grain size (D50) of the glass power is about 1-2 μm. A slurry is prepared by mixing the glass powder and terpineol, and the viscosity of the slurry is about 4×10^{4.5} Pa·s. Screen printing is used to coat the slurry on the stainless steel foil (SUS430, 190 μm thick). It is pre-sintered at 400° C. for 30 min, and then treated at 850° C. for 2 hours. Finally, a glass layer is formed on the stainless steel foil. The surface roughness of the glass is 40 nm from peak to peak. The electrical resistivity is 6×10¹¹ Ω·m. The curvature radius is 50 mm. The shear strength between the glass and the stainless steel foil is 120 MPa/mm².

The original surface of the stainless steel used as shown in FIG. 7 is not smooth, and there are many strips on the surface. After coating a glass layer, the surface becomes smooth. A flexible article made of stainless steel foil coated with glass is shown in FIG. 8. The results of Example 1 show that, after forming a glass layer on the stainless steel foil, the surface roughness is reduced to below 100 nm.

### Example 2

A thin glass (D263, SCHOTT product) with a thickness of 30 μm and a size of 200 mm×200 mm is prepared. The thin glass is placed on a stainless steel foil (SUS430, 150 μm thick), and it is subjected to heat treatment at 900° C. for 2.5 hours, and then cooled, thereby obtaining a flexible article made of thin glass and stainless steel foil. The surface roughness is 30 nm from peak to peak. The electrical resistivity is 1.6×10⁸ Ω·m. The curvature radius is 100 mm. The shear strength between the glass and the stainless steel foil is 220 MPa/mm².

### Example 3

According to glass 3 in Table 1, the raw materials used are oxides, hydroxides, carbonates, and nitrates, etc. After weighting and mixing, the resultant mixture is placed into a platinum crucible. The mixture is melted at 1550-1600° C. in an electric furnace, then made into ribbon by a rotating device. The ribbon is milled into glass powder through a milling device. The medium grain size (D50) of the glass power is about 1-2 μm. A slurry is prepared by mixing the glass powder, terpineol and ethyl cellulose. The stainless steel foil used comprises about 12 wt % of chromium, 3.5 wt % of aluminum, 1 wt % of titanium, about 0.35 wt % of manganese, about 0.3 wt % of silicon, and about 0.025 wt % of carbon, the remaining component is iron. The stainless steel has a thickness of 90 μm. Screen printing is used to coat the glass slurry on the first surface of the stainless steel foil. It is pre-sintered at 100° C. for 30 min, and then screen printing is used to coat the slurry on the second surface of the stainless steel foil, and it is pre-sintered at 100° C. for 30 min, then treated at 850° C. for 3 hours. Finally, two attached thin glass layers are formed on the stainless steel foil. The surface roughness of the glass is 45 nm from peak to peak. The electrical resistivity is 5×10¹² Ω·m. The curvature radius is 150 mm. The shear strength between the glass and the metal foil is 90 MPa/mm².

### Example 4

According to glass 6 in Table 1, the glass slurry is prepared by alkali boroaluminosilicate glass. The viscosity is about 3000 Pa·s. The stainless steel foil (SUS430) with a thickness of 120 μm is dipped into the slurry totally, and the stainless steel foil is drawn at a speed of 3 mm/min. After taking the stainless steel foil out, it is pre-sintered at 400° C. for 40 min, then treat at 850° C. for 1 hour, thereby obtaining a glass encapsulated flexible article made of glass and stainless steel foil. The surface roughness of the glass is 32 nm from peak to peak. The electrical resistivity is 7×10¹¹ Ω·m. The curvature radius is 130 mm. The shear strength between the glass and the stainless steel foil is 220 MPa/mm².

### Example 5

A thin glass with a thickness of 30 μm and a size of 200 mm×200 mm is prepared. Firstly, the glass powder (produced from glass 1) is placed on the stainless steel foil, then the thin glass is placed on the top of the glass powder. The stainless steel foil is SUS304 with a thickness of 100 μm. The sample is pre-sintered at 800° C. for 4 hours to obtain a three layered flexible article made of glass, glass powder and stainless steel foil. The surface roughness of the glass is 30 nm from peak to peak. The electrical resistivity is 1.5×10¹² Ω·m. The curvature radius is 90 mm. The shear strength between the glass and the stainless steel foil is 250 MPa/mm².

### Example 6

Two thin glasses with a thickness of 30 μm and a size of 200 mm×200 mm are prepared. The glass slurry (produced from glass 9 in Table 1) is coated on the top and bottom surface of the stainless steel foil, then the thin glass is placed on the top of the glass slurry. The stainless steel foil is SUS301 with a thickness of 120 μm. The sample is pre-sintered at 100° C. for 30 min, and sintered at 830° C. for 3 hours, thereby obtaining a five layered flexible article made of glass, glass slurry, stainless steel foil, glass slurry and glass. The surface roughness of the glass is 25 nm from peak to peak. The electrical resistivity is 1.5×10¹² Ω·m. The curvature radius is 200 mm. The shear strength between the glass and the stainless steel foil is 300 MPa/mm².

### Example 7

According to the composition of glass 4 in Table 1, the raw materials used are oxides, hydroxides, carbonates, and nitrates, etc. After weighing out and mixing the raw materials, the mixture is placed into a platinum crucible, melting at 1550-1600° C. in an electric furnace with the melt made into a ribbon by a rotating device. The ribbon is milled into powder through a milling device. The medium grain size (D50) of the glass power is about 0.5-1 μm. A slurry is prepared by mixing the glass powder and terpineol, and the viscosity of the slurry is about 4×10^{4.5} Pa·s. Screen printing is used to coat the slurry on the stainless steel foil (SUS430, 190 μm thick). It is pre-sintered at 100° C. for 30 min, and then is treated at 850° C. for 2 hours. Finally, a glass layer is formed on the stainless steel foil. The surface roughness of the glass is 40 nm from peak to peak. The electrical resistivity is 4×10¹¹ Ω·m. The curvature radius is 60 mm. The shear strength between the glass and the stainless steel foil is 140 MPa/mm².

### Example 8

According to glass 9 in Table 1, the raw materials used are oxides, hydroxides, carbonates, and nitrates, etc. After weighting and mixing, the resultant mixture is placed into a platinum crucible. The mixture is melted at 1550-1600° C. in an electric furnace, then made into ribbon by a rotating device. The ribbon is milled into powder through a milling device. D50 is about 2-3 μm. A slurry is prepared by mixing the glass powder and terpineol, and the viscosity of the slurry is about 4.5×10^{4.5} Pa·s. Screen printing is used to coat the slurry on stainless steel foil. The stainless steel foil is stainless steel grade 430 with a thickness of 180 μm. It is pre-sintered at 100° C. for 30 min, then treated at 850° C. for 2 hours, and then treated at 700° C. for 4 hours to form crystallite layers on the top surface and the bottom surface of the glass layer. Finally, a glass layer with crystallite layers on the top surface and the bottom surface is formed on the stainless steel foil. The surface roughness of the glass is 70 nm from peak to peak. The electrical resistivity is 8×10¹¹ Ω·m. The curvature radius is 100 mm. The shear strength between the glass and the stainless steel foil is 180 MPa/mm².

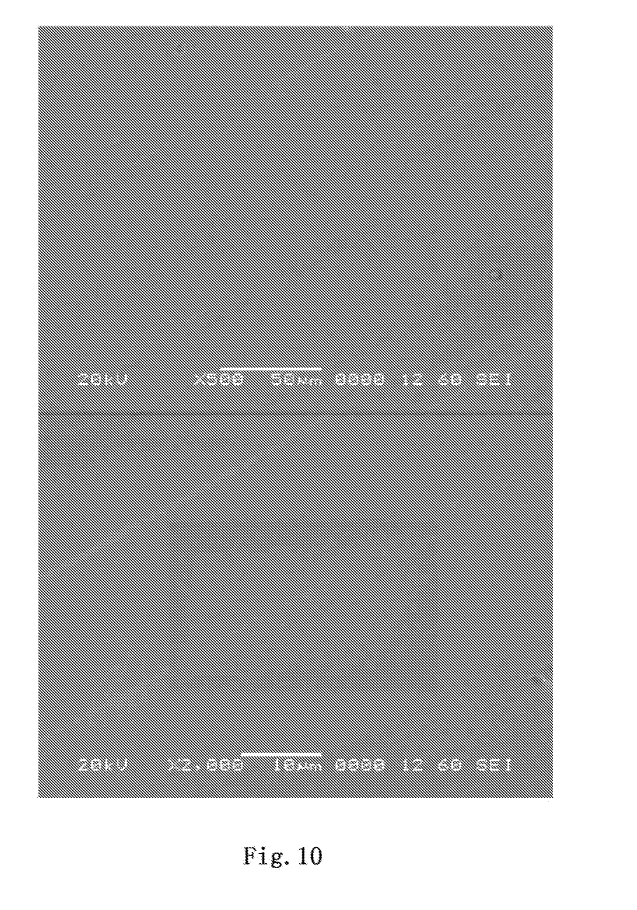

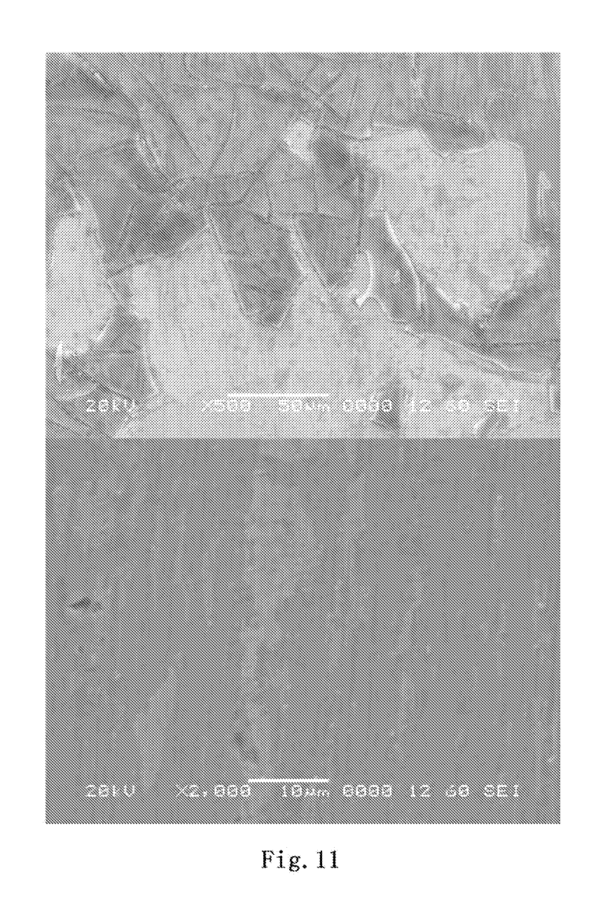

FIG. 10 is the sample prepared according to Example 1. The glass layer is formed by high temperature melting and cooling in the absence of any precursor. The surface is smooth and shining without small “holes” and cracks. The glass surface is dense with a thickness of about 10 μm.

FIG. 11 is the sample prepared according to the sol-gel method by using precursor. The filtered glass precursor composition (0.1 ml) was rod-coated onto a stainless steel and dried at 150° C. for 1 min to form a dried glass precursor layer on the stainless steel. After drying, the coated substrates were calcined to 600° C. for 30 min at a heating rate of 8° C. per minute, thereby obtaining the glass layer of lower than 0.3 μm. The surface is neither smooth nor shining with some small “holes” on the surface. It has been noticed that cracks occur on the glass surface.

What is claimed is:

1. A flexible article suitable for producing substrates of flexible devices, comprising:
a multilayered structure having a layer of glass and a layer of metal foil, the glass being produced by high temperature melting and cooling in the absence of any precursor, wherein the glass has an electrical resistivity of above 5×10¹⁰ Ω·m at ambient temperature, a surface roughness of below 300 nm, a porosity of below 0.1% on the surface, a thickness of below 350 μm, a flowing temperature of below 1200° C., and a softening temperature of above 350° C., and wherein the metal foil has a thickness below 1 mm; and
a shear strength between the glass and the metal foil is above 1 MPa/mm², the multilayered structure being curvable to a curvature radius of above 1 mm.

2. The flexible article according to claim 1, wherein the layer of glass comprises one of a top layer or a bottom layer of the multilayered structure, and wherein the multilayered structure further comprises another layer of glass that comprises another of the top layer or the bottom layer.

3. The flexible article according to claim 2, wherein the multilayered structure further comprises a layer formed from glass powder or glass slurry between the layer of glass and the layer of metal foil.

4. A flexible article suitable for producing substrates of flexible devices, comprising:
a metal foil encapsulated by a shell of glass, wherein the glass has an electrical resistivity of above 5×10¹⁰ Ω·m at ambient temperature, a surface roughness of below 300 nm, a thickness of below 350 μm, a flowing temperature of below 1200° C., a softening temperature of above 350° C., and a porosity of below 0.1% on a surface, wherein the metal foil has a thickness below 1 mm; and
a shear strength between the shell of glass and the metal foil above 1 MPa/mm², wherein the metal foil encapsulated by the shell of glass is curvable to a curvature radius of above 1 mm.

5. The flexible article according to claim 4, wherein the softening temperature is above 400° C.

6. The flexible article according to claim 4, wherein the softening temperature is above 600° C. and the flowing temperature of below 950° C.

7. The flexible article according to claim 4, wherein the glass is selected from the group consisting of silicate glass, phosphate glass, borosilicate glass, aluminosilicate glass, boroaluminosilicate glass, tin phosphate glass, borophosphate glass, titanate glass, barium glass, alkaline metal containing silicate glass, and sodium containing silicate glass.

8. The flexible article according to claim 4, wherein the glass comprises sodium and has a content of Na₂O+SiO₂+P₂O₅+B₂O₃+SO₃+V₂O₅+TiO₂+BaO+ZnO that is 10-95 wt. %.

9. The flexible article according to claim 4, wherein the glass has a content of SiO₂+P₂O₅+B₂O₃ that is 10-90 wt. %.

10. The flexible article according to claim 4, wherein the glass has a composition comprising 0-2 wt. % of a refining selected from the group consisting of As₂O₃, Sb₂O₃, SnO₂, SO₃, Cl, F, CeO₂, and combinations thereof.

11. The flexible article according to claim 4, wherein the glass has a composition, in weight percent, of:

| | |
|---|---|
| SiO₂ | 10-90; |
| Al₂O₃ | 0-40; |
| B₂O₃ | 0-80; |
| Na₂O | 0-30; |
| K₂O | 0-30; |
| CoO | 0-20; |
| NiO | 0-20; |
| Ni₂O₃ | 0-20; |
| MnO | 0-20; |
| CaO | 0-40; |
| BaO | 0-60; |
| ZnO | 0-40; |
| ZrO₂ | 0-10; |
| MnO₂ | 0-10; |
| CeO | 0-2; |
| SnO₂ | 0-2; |
| Sb₂O₃ | 0-2; |
| TiO₂ | 0-40; |
| P₂O₅ | 0-70; |
| MgO | 0-40; |
| SrO | 0-60; |
| Li₂O | 0-30; |
| Li₂O + Na₂O + K₂O | 1-30; |
| SiO₂ + B₂O₃ + P₂O₅ | 10-90; |
| Nd₂O₅ | 0-20; |
| V₂O₅ | 0-50; |
| Bi₂O₃ | 0-50; |
| SO₃ | 0-50; and |
| SnO | 0-70. |

12. The flexible article according to claim 4, wherein the glass has a composition, in weight percent, of:

| | |
|---|---|
| SiO₂ | 10-90; |
| Al₂O₃ | 0-40; |
| B₂O₃ | 0-80; |
| Na₂O | 1-30; |
| K₂O | 0-30; |
| CoO | 0-20; |
| NiO | 0-20; |
| Ni₂O₃ | 0-20; |
| MnO | 0-20; |
| CaO | 0-40; |
| BaO | 0-60; |
| ZnO | 0-40; |
| ZrO₂ | 0-10; |
| MnO₂ | 0-10; |
| CeO | 0-2; |
| SnO₂ | 0-2; |
| Sb₂O₃ | 0-2; |
| TiO₂ | 0-40; |
| P₂O₅ | 0-70; |
| MgO | 0-40; |
| SrO | 0-60; |
| Li₂O | 0-30; |
| Li₂O + Na₂O + K₂O | 5-30; |
| SiO₂ + B₂O₃ + P₂O₅ | 10-90; |
| Nd₂O₅ | 0-20; |
| V₂O₅ | 0-50; |
| Bi₂O₃ | 0-50; |
| SO₃ | 0-50; and |
| SnO | 0-70. |

13. The flexible article according to claim 4, wherein the glass comprises lithium aluminosilicate glass having a composition, in weight percent, of:

| | |
|---|---|
| SiO₂ | 55-69; |
| Al₂O₃ | 19-25; |
| Li₂O | 3-5; |
| Na₂O | 0.5-15; |
| the sum of Na₂O + K₂O | 0.5-15; |
| the sum of | 0-5; |
| MgO + CaO + SrO + BaO | |
| ZnO | 0-4; |
| TiO₂ | 0-5; |
| ZrO₂ | 0-3; |
| the sum of TiO₂ + ZrO₂ + SnO₂ | 2-6; |
| P₂O₅ | 0-8; |
| F | 0-1; and |
| B₂O₃ | 0-2. |

14. The flexible article according to claim 13, wherein the composition further comprises one or more of: coloring oxides selected from the group consisting of Nd₂O₃, Fe₂O₃, CoO, NiO, V₂O₅, MnO₂, TiO₂, CuO, CeO₂, and Cr₂O₃; 0-1 wt. % of rare earth oxides; and 0-2 wt. % of a refining agent selected from the group consisting of As₂O₃, Sb₂O₃, SnO₂, SO₃, Cl, F, CeO₂, and combinations thereof.

15. The flexible article according to claim 4, wherein the glass comprises soda lime glass having a composition, in weight percent, of:

| | |
|---|---|
| SiO₂ | 40-80; |
| Al₂O₃ | 0-6; |
| B₂O₃ | 0-5; |
| the sum of Li₂O + Na₂O + K₂O | 5-30; |
| the sum of | 5-30; |
| MgO + CaO + SrO + BaO + ZnO | |
| the sum of TiO₂ + ZrO₂ | 0-7; and |
| P₂O₅ | 0-2. |

16. The flexible article according to claim 15, wherein the composition further comprises one or more of: coloring oxides selected from the group consisting of Nd₂O₃, Fe₂O₃, CoO, NiO, V₂O₅, MnO₂, TiO₂, CuO, CeO₂, and Cr₂O₃; 0-1 wt. % of rare earth oxides; 0-15 wt. % of black glass; and 0-2 wt. % of a refining agent selected from the group consisting of As₂O₃, Sb₂O₃, SnO₂, SO₃, Cl, F, CeO₂, and combinations thereof.

17. The flexible article according to claim 4, wherein the glass comprises borosilicate glass having a composition, in weight percent, of:

| | |
|---|---|
| SiO₂ | 60-85; |
| Al₂O₃ | 1-10; |
| B₂O₃ | 5-20; |
| the sum of Li₂O + Na₂O + K₂O | 2-16; |
| the sum of | 0-15; |
| MgO +CaO + SrO + BaO + ZnO | |
| the sum of TiO₂ + ZrO₂ | 0-5; and |
| P₂O₅ | 0-2. |

18. The flexible article according to claim 17, wherein the composition further comprises one or more of: coloring oxides selected from the group consisting of Nd₂O₃, Fe₂O₃, CoO, NiO, V₂O₅, MnO₂, TiO₂, CuO, CeO₂, and Cr₂O₃; 0-1 wt. % of rare earth oxides; 0-15 wt. % of black glass; and 0-2 wt. % of a refining agent selected from the group consisting of As₂O₃, Sb₂O₃, SnO₂, SO₃, Cl, F, CeO₂, and combinations thereof.

19. The flexible article according to claim 4, wherein the glass comprises aluminosilicate glass having a composition, in weight percent, of:

| | |
|---|---|
| SiO₂ | 40-75; |
| Al₂O₃ | 10-30; |
| B₂O₃ | 0-20; |
| the sum of Li₂O + Na₂O + K₂O | 4-30; |
| the sum of | 0-15; |
| MgO + CaO + SrO + BaO + ZnO | |
| the sum of TiO₂ + ZrO₂ | 0-15; and |
| P₂O₅ | 0-10. |

20. The flexible article according to claim 19, wherein the composition further comprises one or more of: coloring oxides selected from the group consisting of Nd₂O₃, Fe₂O₃, CoO, NiO, V₂O₅, MnO₂, TiO₂, CuO, CeO₂, and Cr₂O₃; 0-1 wt. % of rare earth oxides; 0-15 wt. % of black glass; and 0-2 wt. % of a refining agent selected from the group consisting of As₂O₃, Sb₂O₃, SnO₂, SO₃, Cl, F, CeO₂, and combinations thereof.

21. The flexible article according to claim 4, wherein the glass comprises low or no alkali metal aluminosilicate glass having a composition, in weight percent, of:

| | |
|---|---|
| SiO₂ | 50-75; |
| Al₂O₃ | 7-25; |
| B₂O₃ | 0-20; |
| the sum of Li₂O + Na₂O + K₂O | 0-4; |
| the sum of | 5-25; |
| MgO + CaO + SrO + BaO + ZnO | |
| the sum of TiO₂ + ZrO₂ | 0-10; and |
| P₂O₅ | 0-5. |

22. The flexible article according to claim 21, wherein the composition further comprises one or more of: coloring oxides selected from the group consisting of Nd₂O₃, Fe₂O₃, CoO, NiO, V₂O₅, MnO₂, TiO₂, CuO, CeO₂, and Cr₂O₃; 0-1 wt. % of rare earth oxides; 0-15 wt. % of black glass; and 0-2 wt. % of a refining agent selected from the group consisting of As₂O₃, Sb₂O₃, SnO₂, SO₃, Cl, F, CeO₂, and combinations thereof.

23. The flexible article according to claim 4, wherein the metal foil comprises a metal selected from the group consisting of Fe, Cu, Al, Cr, Co, Ag, Ni, and any alloys thereof.

24. The flexible article according to claim 4, wherein the metal foil comprises stainless steel.

25. The flexible article according to claim 4, wherein the glass has a thermal expansion coefficient in a temperature range of 20-300° C. from 1×10⁻⁶/K to 25×10⁻⁶/K.

26. The flexible article according to claim 4, wherein the flexible article is subject to a treatment selected from the group consisting of cutting, milling, polishing, and drilling.

27. The flexible article according to claim 26, wherein the treatment is carried out in an atmosphere selected from the group consisting of air, a reducing atmosphere, an atmosphere with a small amount of oxygen, nitrogen, and a mixture of nitrogen and hydrogen.

28. The flexible article according to claim 4, wherein the glass has a surface that is chemically toughened and has a DoL of >1 μm and a CS of >200 MPa.

29. The flexible article according to claim 4, wherein at least a portion of the glass is crystallized to a glass ceramic.

30. The flexible article according to claim 29, wherein the glass ceramic has a crystalline phase selected from the group consisting of a high quartz solid solution, lithium disilicate, barium disilicate, enstatite, wollastonite, stuffed β-quartz, β-spodumene, cordierite, mullite, potassium richterite, canasite, spinel solid solution, quartz, and borate.

31. The flexible article according to claim 4, wherein the glass has thickness below 300 μm and/or a surface roughness below 1 nm.

32. A process for producing a flexible article, comprising:
melting a glass at high temperature;
cooling the glass; and
laminating the glass with a metal foil.

33. The process according to claim 32, further comprising forming the glass into a thin glass prior to cooling.

34. The process according to claim 33, wherein the step of laminating comprises directly laminating the thin glass with the metal foil after the cooling step.

35. The process according to claim 33, wherein the step of laminating comprises adhering the thin glass to the metal foil by a binder comprising a glass slurry.

36. The process according to claim 35, wherein the glass slurry comprises a glass powder, the glass power comprising glass that has been high temperature melted and cooled.

37. The process according to claim 36, wherein the step of forming the glass into the thin glass comprises a process selected from the group consisting of an up drawing process, a down draw process, an overflow process, and a float process.

38. The process according to claim 32, further comprising:
milling the glass into a powder after the cooling step; and
mixing the powder with an organic solution to obtain a glass slurry,
wherein the laminating step comprises coating the slurry on the metal foil.

39. The process according to claim 38, wherein the step of coating the slurry comprises a process selected from the group consisting of screen printing, dip coating, rolling coating, and spray coating.

40. The process according to claim 32, further comprising milling the glass into a powder after the cooling step, wherein the laminating step comprises electrostatic coating of the powder on the metal foil.
